(19) United States
(12) Patent Application Publication
(10) Pub. No.: US 2016/0336834 A1
(43) Pub. Date: Nov. 17, 2016

(54) SYNCHRONOUS GENERATOR IN A GEARLESS WIND TURBINE

(71) Applicant: WOBBEN PROPERTIES GMBH, Aurich (DE)

(72) Inventor: Volker Diedrichs, Wardenburg (DE)

(21) Appl. No.: 15/112,658

(22) PCT Filed: Dec. 11, 2014
(86) PCT No.: PCT/EP2014/077392

§ 371 Date: Jul. 19, 2016

(30) Foreign Application Priority Data
Jan. 20, 2014 (DE) 10 2014 200 947.2

(51) Int. Cl. H02K 7/18; H02K 19/16; H02K 11/04; H02K 11/049; H02K 1/16; H02K 29/03

(52) U.S. Cl. CPC H02K 7/1838; H02K 1/165; H02K 29/03; H02K 11/046; H02K 11/049; H02K 19/16; H02K 2213/03

(57) ABSTRACT

A synchronous generator, in particular a multipole synchronous ring generator of a gearless wind turbine for generating electric current, comprising a rotor and a stator having teeth and slots arranged therebetween for receiving a stator winding, wherein the stator is divided in a circumferential direction into stator segments, each having a plurality of teeth and slots, and at least two stator segments being offset or interleaved with respect to one another in a circumferential direction.

### BACKGROUND

1. Technical Field

The present invention relates to a synchronous generator, in particular to a multipole synchronous ring generator, of a gearless wind turbine. In addition, the present invention relates to a set of laminations for producing a stator laminate stack of a stator of such a synchronous generator and to a corresponding method for producing such a stator laminate stack. In addition, the present invention relates to a wind turbine comprising a synchronous generator.

2. Description of the Related Art

Wind turbines are generally known and generate electric current from wind by means of a generator. Modern gearless wind turbines often have a multipole synchronous ring generator with a large air-gap diameter. The diameter of the air gap is in this case at least 4 meters and generally reaches up to almost 5 meters. Assembled synchronous generators can even have an air-gap diameter of approximately 10 meters.

During operation of the wind turbine, i.e., of the synchronous generator in question, noise is developed which, owing to the large physical form, can also find large resonance bodies such as, for example, the nacelle cladding of a nacelle enclosing or at least partially enclosing the synchronous generator. On the basis of their function, such synchronous generators of a gearless wind turbine are very slowly rotating generators which rotate at a typical speed of approximately 5 to 35 revolutions per minute. This slow speed can also generate special noises correspondingly, in particular in comparison with generators which rotate at 1500 or 3000 revolutions per minute.

Such synchronous generators of gearless wind turbines and therefore the wind turbines can become a permanent disruptive source of noise owing to their continuous operation. Nowadays, particularly large, modern wind turbines are increasingly installed at a greater distance from populated areas and operated there so that any noise from the wind turbine is also less disruptive.

By virtue of the installation at a greater distance, however, the actual problem of noise development is not in principle eliminated, but effectively only moved.

The German Patent and Trademark Office has searched the following prior art for the priority application in respect of the present PCT application: U.S. Pat. No. 6,321,439 B1, DE 10 2009 015 044 A1, WO 2011/128 095 A2, DE 103 40 114 A1, DE 10 2005 061 892 A1, US 2004/0 036 374 A1, DE 199 23 925 A1, DE 101 10 466 A1, U.S. Pat. No. 4,315,171 A and DE 15 38 772 B2.

### BRIEF SUMMARY

A synchronous generator is proposed, in particular a multipole synchronous ring generator of a gearless wind turbine. Such a multipole synchronous ring generator of a gearless wind turbine has a multiplicity of stator poles, in particular at least 48 stator teeth, often even considerably more stator teeth, such as, in particular, 96 stator teeth or even more stator teeth. The magnetically active region of the generator, namely both the rotor, which can also be referred to as the armature, and the stator, is arranged in a ring-shaped region around the axis of rotation of the synchronous generator. Thus, in particular a region of 0 to at least 50 percent of the radius of the air gap is free of materials which conduct electric current or the electrical field of the synchronous generator. In particular, this interior is completely free and can in principle also be accessed. Often, this region is also more than 0 to 50 percent of the air-gap radius, in particular up to 0 to 70 percent or even 0 to 80 percent of the air-gap radius. Depending on the design, a supporting structure can be provided in this inner region, but this supporting structure can be axially offset in some embodiments.

The synchronous generator therefore has a rotor and a stator. The rotor is sometimes referred to as armature in order to also distinguish it in wording from the aerodynamic rotor of the wind turbine.

The stator is provided with teeth and slots arranged therebetween. The slots receive a stator winding, or a plurality of stator windings, so that the stator winding is therefore arranged through the slots and around the teeth.

The stator is divided in a circumferential direction into stator segments, each having a plurality of teeth and a plurality of slots, and at least two stator segments being offset or interleaved with respect to one another in a circumferential direction. All of the stator segments are arranged next to one another in the circumferential direction and furthermore in particular are interleaved or offset with respect to one another approximately through a quarter of a slot width or another magnitude, namely such that the slots and the teeth of a stator segment alternate uniformly in the circumferential direction and this uniformity is interrupted at the transition to the next, adjacent stator segment by virtue of a wider or narrower slot, a wider or narrower tooth or an additional, possibly narrower tooth or an additional, possibly narrower slot being arranged there or a tooth being omitted. The transition can in principle also be realized in another way. Then, slots and teeth alternate again uniformly, in particular with in each case the same slot width or in each case the same tooth width, on the next, adjacent stator segment.

As a result, rotor or armature poles which are distributed completely uniformly in a circumferential direction do not now in each case reach the teeth or slots of the stator segments which are offset or interleaved with respect to one another precisely at the same time during the rotary motion of the rotor, but earlier or later by this offset or this interleaving. Therefore, while a rotor pole reaches a stator tooth of a stator segment, a corresponding rotor pole reaches a stator tooth of another, interleaved or offset stator segment with a slight time shift. As a consequence, oscillating, in particular sinusoidal currents which are slightly shifted with respect to one another are produced in these stator segments which are interleaved or offset with respect to one another. This in turn results in these currents being capable of producing harmonics with a reduced amplitude when superimposed. Similarly, direct superimposition of noises of the same frequency but of a different phase can also result in an overall reduction in the noise, in particular the noise level. These two described effects can also interact with one another such that synergy effects can be utilized which can result in an overall more pronounced noise reduction.

For example, the stator can be divided into four stator segments 1 to 4, and each stator segment can have, and this is also only mentioned by way of example, in each case 12 stator teeth, with the result that the stator comprises in total 48 teeth and to this extent would be a comparatively smaller multipole synchronous ring generator of a gearless wind turbine. The first and third stator segments and therefore the slots and teeth of these stator segments would be offset or interleaved with respect to the second and fourth stator segments, i.e., the slots and teeth thereof, respectively.

Preferably, at least one tooth forms a stator pole, and correspondingly two stator poles form a pole pair, which is used conceptually here for simplicity for stator pole pair. In principle, a stator pole could also be formed from a plurality of teeth or a split tooth, which is of no great importance here. In any case, with respect to this embodiment it is proposed that the number of pole pairs of each stator segment is a multiple of two. In particular, the number of pole pairs of each stator segment is a multiple of six. Such a configuration whereby namely the number of pole pairs of each stator segment is at least a multiple of two enables the provision of part-windings for each stator segment. Thus, each stator segment can be in the form of an independent generator or an independent virtual generator which to this extent only shares the rotor with the other stator segments.

If the number of pole pairs of each segment is a multiple of six, a described independent stator segment can be provided with three-phase windings, in particular even with two independent three-phase windings. Both three-phase windings can correspondingly generate a three-phase current signal, and the three-phase current signals of these two independent three-phase windings can be shifted with respect to one another. Downstream rectification is thus improved. The current signal can also simply be referred to as current.

Preferably, four stator segments are provided, and the stator segments are grouped into two segment groups, each having two stator segments. For this purpose, it is proposed that the number of pole pairs of each segment group is a multiple of four. As a result, it is possible for each stator segment, as described above, to be wound independently and for at the same time the stator segments to be provided in principle symmetrically, with the result that, therefore, all stator segments are of equal size, in simple terms, i.e., in each case occupy a quadrant. If a tooth has been omitted at the transition between two adjacent stator segments which are interleaved with respect to one another, this (omitted) tooth nevertheless needs to be included in the calculation. In other words, a stator pole without a dedicated tooth or a stator pole pair with only a single dedicated tooth would be present here. The effect of the pole pair is nevertheless provided by the corresponding winding section, the one tooth and one or more other teeth.

Alternatively, if the number of pole pairs of each segment group is not a multiple of four, it is proposed that the stator segments of a segment group have different numbers of pole pairs. For example, a stator with in total 84 pole pairs, i.e., in particular 168 teeth, can be split into two segment groups, each having two stator segments. The stator segments of these two segment groups alternate with one another. Thus, each segment group has two stator segments and each segment group has 42 pole pairs and in this case, for example, one stator segment with 24 pole pairs and one stator segment with 18 pole pairs.

For this and other embodiments, it is proposed that each segment group is connected in each case to a rectifier in the form of a B12 bridge. In this case, each segment group can be wound in such a way that it produces two three-phase systems as output current. These two three-phase systems which therefore, as a result, produce six different phase currents, are rectified by means of this B12 bridge. Each phase is therefore supplied to a branch of this B12 bridge, which, in a known manner, rectifies this phase with two diodes. The rectified current of each of these phases is given to a common DC link or another DC voltage storage device or DC storage device.

By virtue of the fact that both segment groups are connected to a B12 bridge and both segment groups each produce two three-phase currents which are rectified, a rectified total signal with very few harmonics can be achieved. This is achieved particularly by virtue of the fact that at least two stator segments or two segment groups are offset or interleaved with respect to one another in the circumferential direction. As a result, the six phases of one segment group are once again shifted with respect to the six phases of the other segment group in such a way that their superimposition in the rectified total signal is reduced and therefore results in as few harmonics as possible.

Preferably, slots and teeth of in each case one stator segment are arranged equidistantly, and the at least two stator segments are offset or interleaved with respect to one another in the circumferential direction in such a way that adjacent teeth of the adjacent stator segments or adjacent slots of the adjacent stator segments have a different spacing from one another than adjacent teeth or slots of the same stator segment. The slots and teeth are therefore in each case arranged equidistantly within their stator segment, in particular such that all slots of a stator segment and in particular of the entire stator have the same width, i.e., extent in the circumferential direction, apart from slots in the transition or contact region between two adjacent stator segments. Correspondingly, all teeth of a stator segment or even of the entire stator also have the same width, i.e., extent in the circumferential direction, apart from teeth in the transition or contact region between two adjacent stator segments.

The proposed configuration of the stator therefore corresponds to a stator with completely uniform teeth and slots in the circumferential direction, wherein this stator is split into stator segments, in particular an even number of stator segments of equal size, and then in particular every second stator segment would be, theoretically, rotated about the axis of rotation of the generator through a proportion of a slot width or tooth width.

In accordance with an embodiment, a synchronous generator comprising a stator is proposed, in which a first and a second slot of a first stator segment or a first and a second tooth of the first stator segment have an average spacing with respect to one another of n×a. The variable a in this case denotes the average spacing between two adjacent slots or teeth of the first stator segment. This therefore describes the spacing between, for example, the center of the first slot and the center of the second slot or the center of the first tooth and the center of the second tooth. Preferably, this is identical to the average of each spacing between adjacent teeth of the entire stator.

The variable n is the number of slot spacings or tooth spacings, i.e., a number which is less than the number of slots between the first and second slot under consideration by a value of 1 or a number which is less than the number of teeth between the first and second teeth under consideration by a value of 1.

The spacing between the first and a further slot, wherein the further slot is located on a second stator segment, or the spacing between the first tooth and a further tooth, which is located on the second stator segment, is n×a+v or n×a−v.

In this case, the variable v denotes the offset or the interleaving between the first and second stator segments. This interleaving is to this extent greater than 0, but less than the average slot spacing or average tooth spacing a. Whether this offset v is added or subtracted is dependent on whether the offset or the interleaving in the case of the two stator segments under consideration is such that said stator segments are interleaved or offset towards one another, in which case the variable v would be subtracted, or whether they are offset or interleaved away from one another, in which case the variable v would be added.

It can therefore be seen from this formulaic description that the teeth or slots of a stator segment are spaced apart from one another by an n-fold average spacing, whereas in addition also once the offset v is to be added to or subtracted from a next stator segment which is interleaved or offset with respect thereto. In principle, to this extent also the offset v and the slot spacing a or tooth spacing a should be understood to mean a spacing along the circumference or understood to mean an angle based on the axis of rotation of the generator and therefore the mid-axis of the stator.

Preferably, the offset or the interleaving has a value of 0.4 to 0.6 slot spacings or tooth spacings a. In particular, the offset is approximately half such a slot spacing or tooth spacing a. As a result, the noises and/or currents generated in the respective stator segments have such a phase shift with respect to corresponding noises or currents that the noise development resulting overall for the synchronous generator is as low as possible. This is achieved in particular by a favorable superimposition of the components in question, which therefore reduce one another.

Preferably, each stator segment receives part of the stator winding or stator windings as winding segment, and winding segments of non-adjacent stator segments are interconnected to one another. As a result, in addition to the mechanical interleaving or the mechanical offset of the stator segments, also a corresponding electrical interleaving is provided. This takes place in particular in such a way that non-adjacent stator segments, i.e., in particular every second stator segment, are interconnected with one another, i.e., in particular in a parallel circuit or in a series circuit. These stator segments generate a current of the same frequency and phase angle in their winding segments. The other stator segments arranged between these non-adjacent stator segments and therefore stator segments which are likewise nonadjacent with respect to one another, i.e., in principle a second group of non-adjacent stator segments, are likewise interconnected with one another and together generate a current with the same frequency and phase angle. In this case, a three-phase current is usually present, which also applies to the corresponding first group of non-adjacent stator segments. Preferably, the interleaving is performed in each case as a series circuit, with the result that the winding segments can be interconnected directly there with the next winding segment of the next non-adjacent stator segment. Therefore, it is possible to avoid too many lines being routed parallel to one another.

Preferably, the winding segments are connected alternately to a first and a second rectifier. Therefore, the winding segments of the first group of non-adjacent stator segments are connected to the first rectifier, and the winding segments of the second group of non-adjacent stator segments are connected to the second rectifier. Correspondingly, the current of these two groups is rectified during operation by the respective rectifier and fed to a DC link, which is preferably common to both rectifiers. As a result, it is also possible for the two rectifiers to receive currents which are phase-shifted with respect to one another and correspondingly to feed the common DC link, as a result of which the harmonics can be reduced there. As a result, harmonics are also reduced here, which in turn can have positive effects on the development of noise, i.e., can reduce this noise development.

Preferably, the stator and/or the stator winding is point-symmetrical, in particular point-symmetrical with respect to the axis of rotation of the synchronous generator. The interleaving or the offset of the stator segments with respect to one another can have, in section, no mirror symmetry, but owing to the point symmetry, which can expediently also be referred to as rotational symmetry, can overall achieve a uniform arrangement such that, owing to the offset or the interleaving, the described reduction in noise can be achieved, but the generator can run smoothly uniformly.

Preferably, it is proposed that all of the slots of the stator are identical, i.e., unchanged by the offset or the interleaving. The offset or the interleaving is instead achieved by correspondingly matched teeth. These teeth can be increased or reduced in size, for example, in the circumferential direction in the contact region of adjacent stator segments for this purpose. An additional tooth can also be provided in each case. As a result, it is in particular also the case that the line phases of the stator winding can be laid in the same way in all of the slots in the usual way.

Preferably, the synchronous generator is characterized by the fact that the stator winding or the winding segments have, phase by phase, winding phases. In each case one such winding phase is laid through a first slot, i.e., passed forwards in principle, and passed back through a second slot. Such laying through these first and second slots is repeated at least once so that at least one loop is laid through these two slots and therefore around the teeth therebetween. Preferably, three loops are laid through these two slots and around the teeth therebetween, with the result that, in terms of electromagnetic effectively, four turns are provided. The laying of this winding phase is then continued correspondingly in a third and fourth slot.

The winding phases of other phases are likewise laid correspondingly. Preferably, three loops are laid through these two coils and therefore around the teeth therebetween. As a result, a good ratio between the complexity involved in the winding, on the one hand, and the efficiency of the synchronous generator during operation, on the other hand, can be achieved. In particular the use of three loops is particularly advantageous for the synchronous generator of a wind turbine which is operated without a gear mechanism. Three loops make it possible to lay the respective winding phases for a stator segment continuously. For this, winding phases which have a large effective line cross section which comprises a multiplicity of individual lines but can still be handled during winding are required. At the same time, an unnecessarily large number of winding steps owing to an excessively thin winding phase are avoided, and a situation whereby an excessively thick winding phase needs to be used in the case of even fewer loops, which excessively thick winding phase would make handling more difficult, is avoided, or at least the splitting of a winding phase into two parallel winding phases is avoided.

Preferably, five slots and six teeth are located between the first and second slots or in the at least one loop. The remaining five slots can be provided for five winding phases for five further phases.

Preferably, a winding phase is wound continuously through a stator segment and in particular continuously through all stator segments of a segment group. As a result, problems in respect of connection points can be avoided and, in the case of the continuous, interruption-free winding of a winding phase for all stator segments of a segment group, these stator segments can be connected electrically in series correspondingly in a simple manner.

According to the invention, a set of laminations comprising a plurality of stator laminations for assembly to form a stator laminate stack is also proposed. This set of laminations is preferably designed such that it can produce a stator laminate stack of a synchronous generator in accordance with one of the above-described embodiments.

The stator laminations of this set of laminations all together have a plurality of slots and teeth. The set of laminations in this case distinguishes between three types of stator laminations, namely a normal lamination, an expanded lamination and a compressed lamination. The normal lamination in principle corresponds to a conventional, known lamination of a stator of a synchronous generator without an offset or interleaving. A stator laminate stack can be assembled from a plurality of such normal laminations. For this purpose, a correspondingly large number of normal laminations are laid in a circle in a first layer and a second layer is laid thereon in the same way, but with an offset with respect to the laminations of the first layer, and so on until the stator laminate stack is formed by a plurality of such lamination layers which are offset with respect to one another.

In order to achieve a stator laminate stack in which stator segments are provided and are offset or interleaved with respect to one another, however, further laminations are required which take into account this offset or interleaving. For this purpose, the expanded lamination and the compressed lamination are provided. The expanded lamination in principle corresponds in nature also to the normal lamination, but has an expanded region, in particular a widened tooth. This expanded region is therefore provided for the transition region between two stator segments which are interleaved or offset with respect to one another, i.e., which are removed from one another corresponding to the offset or interleaving. This results in this expanded region provided by this expanded lamination.

Correspondingly, the compressed lamination has a compressed region, which is provided for the transition region between two stator segments which are offset or interleaved with respect to one another.

Preferably, these expanded or compressed regions are not in the center of the expanded lamination or compressed lamination in question, but are eccentric, approximately by a third. In addition, these expanded regions or compressed regions are mirror-symmetrical, with the result that their configuration remains unchanged when the corresponding expanded or compressed lamination is inverted from an upper side to a lower side, or vice versa.

Thus, these compressed laminations or expanded laminations can also be layered one on top of the other so as to overlap one another in various layers, with the result that the respective expanded regions or compressed regions come to lie precisely one on top of the other without the corresponding expanded laminations or compressed laminations overall coming to lie precisely one on top of the other. Therefore, an overlapping layered structure can be formed when producing the laminate stack even in the region of the expanded regions or compressed regions without in each case different laminations needing to be produced. The manufacturing depth for this therefore only needs to comprise a normal lamination, an expanded lamination and a compressed lamination. With these three different types of laminations, the entire laminate stack can be produced, including the expanded and compressed regions, i.e., including the transition regions between stator segments which are offset or interleaved with respect to one another, including overlap.

In addition, a method for producing a stator laminate stack is proposed which builds on the production of a stator laminate stack with the aid of a set of laminations in accordance with one of the above-described embodiments. It is therefore proposed here that the stator laminate stack is constructed in layers initially in the usual way, with in each case one expanded lamination or one compressed lamination being arranged for the transition regions. For the next layer, an expanded lamination or compressed lamination is provided in the respective region, but this expanded or compressed lamination is inverted with respect to the lamination beneath it in each case, i.e., with the upper side at the bottom or the lower side at the top. By virtue of the eccentric arrangement of the expanded region or compressed region, the inversion of the lamination changes the position of said lamination and therefore an overlapping stacking, i.e., one in which the laminations do not rest completely one on top of the other, can be achieved with one and the same lamination.

In accordance with the invention, in addition a wind turbine comprising a synchronous generator in accordance with one of the above-described embodiments is proposed.

### BRIEF DESCRIPTION OF THE SEVERAL VIEWS OF THE DRAWINGS

The invention will be explained in more detail below on the basis of exemplary embodiments by way of example with reference to the accompanying figures.

FIG. 1 shows a wind turbine schematically in a perspective view.

FIG. 2 shows an axial sectional view of a known synchronous generator.

FIG. 3 shows, schematically, a circuit diagram of a known separately excited synchronous generator comprising two three-phase windings and a downstream diode rectifier.

FIG. 4 shows a synchronous generator according to the invention in an axial sectional view.

FIGS. 4A and 4B show details from FIG. 4.

FIGS. 5A to 5D show various possible implementations of a transition region as embodiments with respect to the detail shown in FIG. 4A.

FIG. 6 shows, schematically, one possibility for the circuitry of the segments of a synchronous generator with downstream rectifier.

FIG. 7 shows a synchronous generator in an axial sectional view in accordance with a further embodiment comprising stator segments with different numbers of pole pairs.

FIG. 7A shows a detail from FIG. 7.

FIG. 8 illustrates a winding scheme of a synchronous generator of one embodiment.

FIG. 9 illustrates a winding scheme of a synchronous generator of a further embodiment.

### DETAILED DESCRIPTION

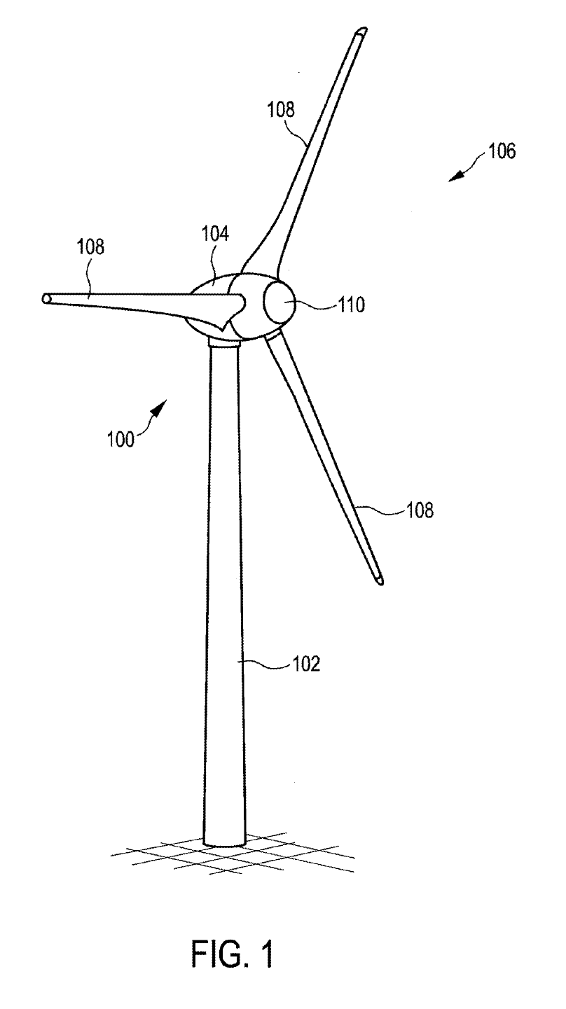

FIG. 1 shows a wind turbine 100 comprising a tower 102 and a nacelle 104. A rotor 106 with three rotor blades 108 and a spinner 110 is arranged on the nacelle 104. The rotor 106 is set in rotary motion during operation by the wind and thus drives a generator in the nacelle 104.

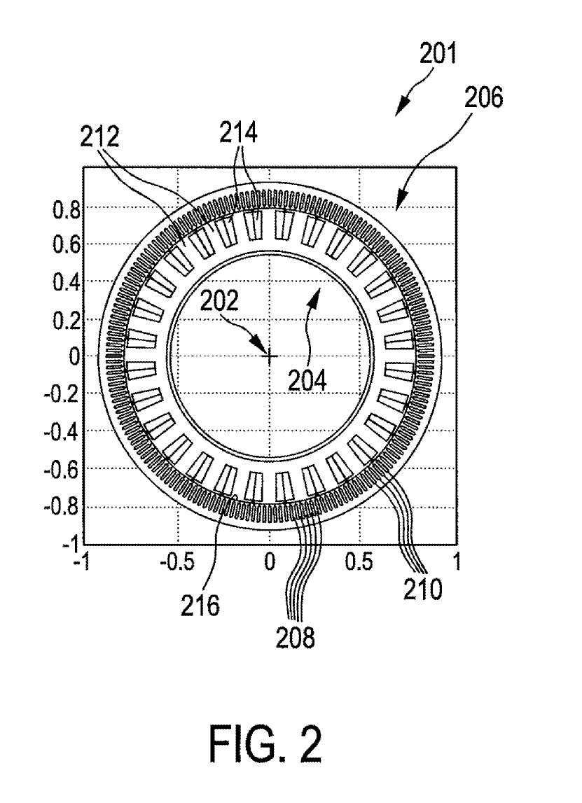

FIG. 2 shows a known synchronous generator 201 in an axial sectional view, i.e., in a view in the direction of the axis of rotation 202, wherein the synchronous generator 201 is sectioned transversely to the axis of rotation 202. The synchronous generator is in the form of an internal-rotor synchronous generator and therefore has a rotor or armature 204 on the inside and a stator 206 on the outside. The synchronous generator 201 is in the form of a multipole ring generator and has a free interior, which takes up over half the total diameter or total radius of the synchronous generator 201. 168 stator teeth 208 are provided by way of example. The same number of stator slots 210 is provided, which stator slots alternate with the stator teeth 208 or are arranged therebetween.

The armature 204 has some rotor poles or pole shoes 212, between which in each case slots 214 with windings are provided. The rotor slots 214 are provided with windings for exciting the rotor.

During operation, the rotor 204 rotates relatively to the stator 206, and the rotor poles 212 brush past the stator poles 208. A narrow air gap 216 is provided between the rotor 204 and the stator 206.

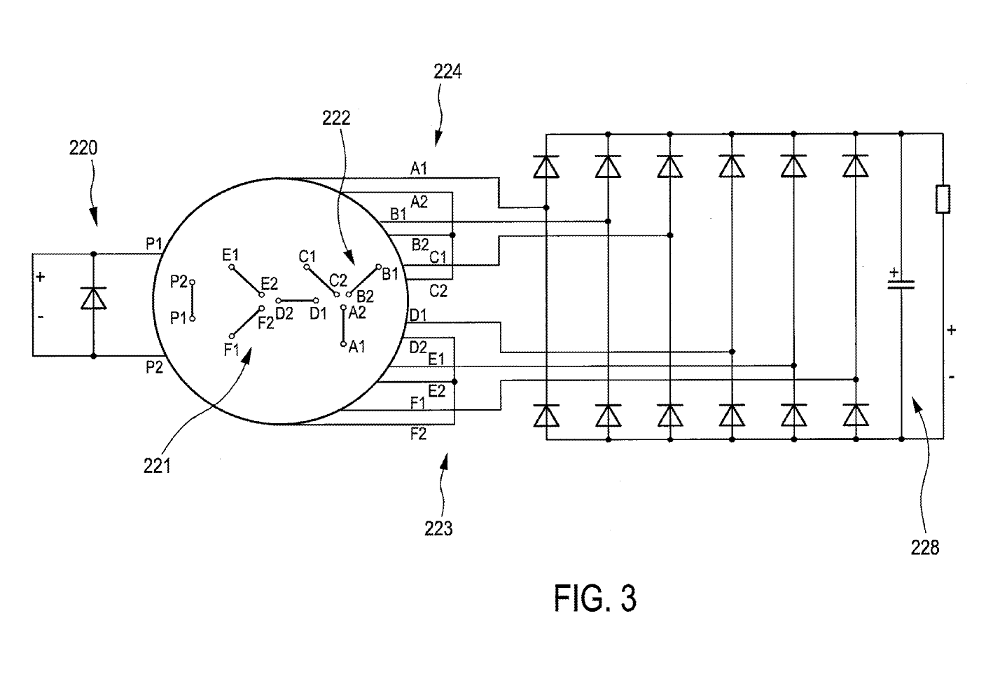

FIG. 3 illustrates wiring of a known synchronous generator 201 and shows schematically a field circuit 220 for exciting the rotor 204 by means of a direct current. A first and a second three-phase stator winding 221 and 222, respectively, are shown schematically. Said stator windings are interconnected via a first interconnection 223 or a second interconnection 224 via a first or second rectifier 225 and 226, respectively, and the two rectifiers 225 and 226 feed a common DC link 228, which is symbolized by a capacitor.

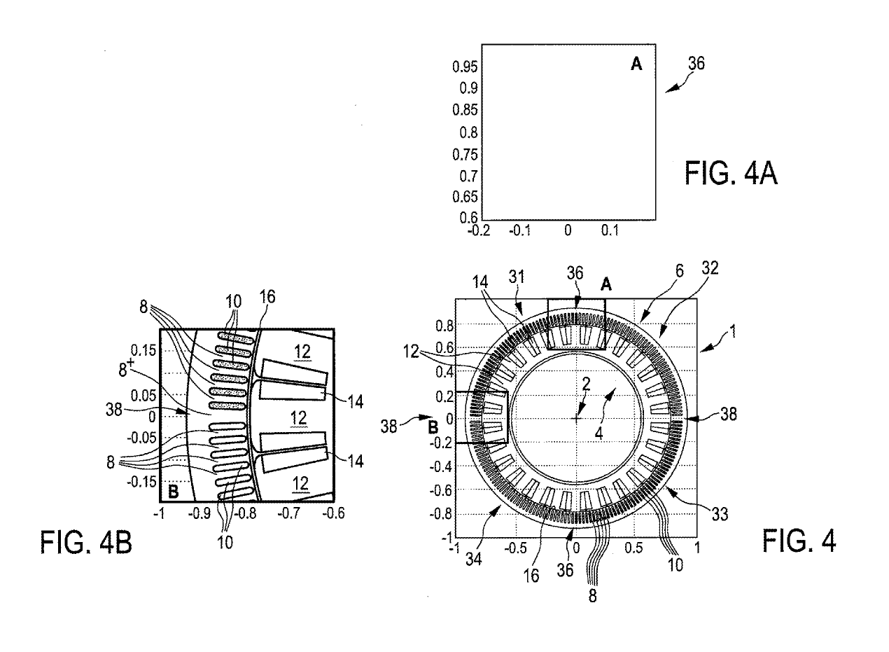

FIG. 4 now shows, in a manner quite similar to FIG. 2, a synchronous generator 1 comprising an axis of rotation 2, an armature or rotor 4, a stator 6 and a multiplicity of stator teeth 8 and the same number of stator slots 10. The armature or rotor 4 has rotor poles or pole shoes 12 and rotor slots 14 therebetween. An air gap 16 is located between the stator 6 and the armature 4. The rotor or armature 4 is identical to the rotor or armature 204 in FIG. 2 except that the stator 6 differs from the stator 206 in FIG. 2 in accordance with the invention.

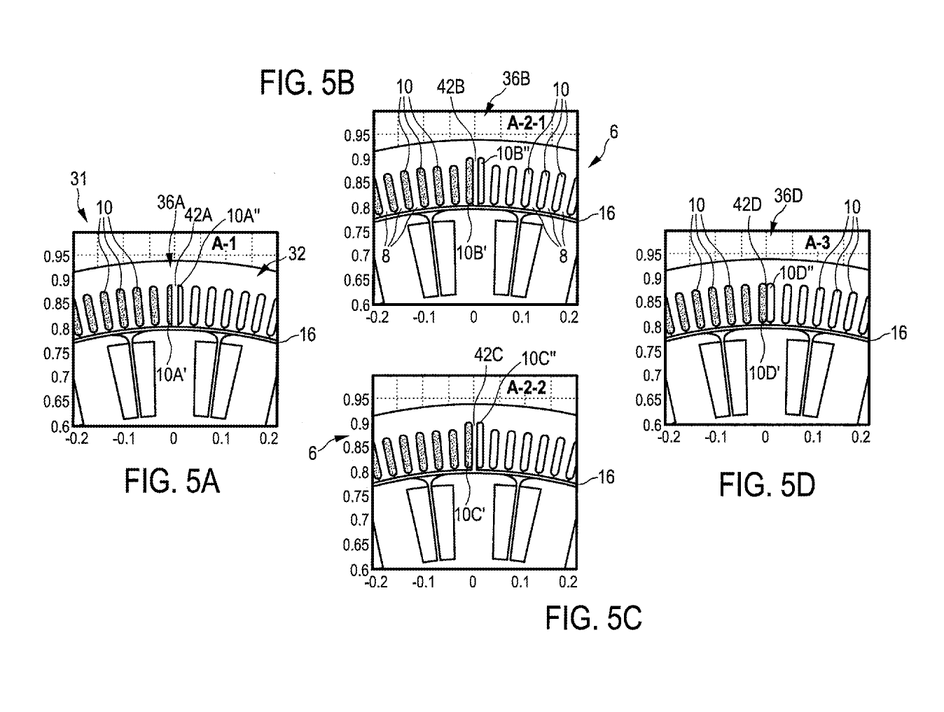

To this extent, the stator 6 is divided into four segments 31 to 34. In each case adjacent segments are interleaved or offset with respect to one another. Thus, the first and third segments 31, 33 are not interleaved or offset with respect to one another but relative to the second and fourth segments 32, 34, respectively. Likewise, the second and fourth segments 32, 34 are not interleaved or offset with respect to one another. There is thus a compressed region 36 or an expanded region 38 between adjacent segments, depending on whether the respectively adjacent segments are offset or interleaved towards one another or away from one another. FIG. 4A in this case shows a detail of the synchronous generator 1, which relates to a compressed region 36. Possibilities for the implementation of this compressed region 36 are shown in FIGS. 5A-5D. FIG. 4B shows a detail of the synchronous generator 1 which includes an expanded region 38.

It can be seen in respect of the expanded region 38 from FIG. 4B that a widened stator tooth 8⁺ is provided, whereas the remaining stator teeth 8 have a smaller width in relation to this, namely a normal width and are also identical in width with one another.

Correspondingly, FIG. 4A should have a narrowed tooth 8⁻ or another implementation of the compressed region for the compressed region 36, wherein all stator slots 10 have the same size and shape, but this is only one possibility for the implementation. FIG. 4A is merely a placeholder for possibilities for the implementation which are illustrated specifically in FIGS. 5A to 5D.

The enlargements in FIGS. 4B and 5A to 5D also show that, of the armature or rotor 4, the teeth 12 and slots 14 are untouched by the segmentation and interleaving or compressing of the stator 6.

FIGS. 5A to 5D therefore show details in accordance with the detail or placeholder in FIG. 4A and in this case show different possibilities for the specific configuration of the compressed region 36, which is designated correspondingly as 36A, 36B, 36C and 36D in these FIGS. 5A to 5D, respectively. In this compressed region, the two stator segments 31 and 32 are rotated towards one another with respect to a conventional arrangement, which is shown in FIG. 2, for example. This is approximately by the measure of a slot width, wherein, in the configuration shown in FIG. 4 and therefore also as shown in FIGS. 5A to 5D, the slot width approximately corresponds to the width of the web 40 of each tooth 8.

Preferably, this rotation of the two adjacent regions towards one another corresponds approximately to half an average tooth spacing or slot spacing, i.e., to half a spacing from tooth center to the center of the next tooth or from the center of a slot to the center of the next adjacent slot.

In order to implement the compressed region 36A, the embodiment shown in FIG. 5A proposes configuring the slots 10A′ and 10A″ directly adjacent to one another so as to be narrower and to provide a separating web 42A therebetween. This separating web 42A can separate these two slots 10A′ and 10A″ from one another and thus also separate any inserted lines of the stator winding from one another. To this extent, this separating web 42A can also have an electrically insulating function. One problem here consists in that the slots 10A′ and 10A″ are reduced in size in comparison with the slots 10 and can therefore also receive lines of the stator winding to a lesser or poorer extent.

As an alternative, a configuration as shown in FIG. 5B is therefore proposed, in which two limit slots 10B′ and 10B″ are provided in the compressed region 36B, which limit slots have a greater depth than the remaining slots 10. The limit slots 10B′ and 10B″ are therefore slimmer, but deeper and can therefore receive approximately the same number of lines or line cores as the other slots 10. The two limit slots 10B′ and 10B″ are separated by a separating web 42B, which can comprise the same material as the remaining teeth 8 and the laminate stack of the stator 6 anyway.

FIG. 5C shows a very similar configuration to that shown in FIG. 5B, but a separating web 42C is provided which is manufactured from a different material than the stator laminate stack, i.e., from the remaining stator teeth 8. The material of the separating web 42C is manufactured from a highly permeable material, at least a material which has a higher degree of permeability than the stator lamination. For this, so-called Mu metal can be used, for example. Owing to this highly permeable material, the reduced cross section of this separating web 42C can be wholly or partially compensated for. In contrast to the embodiment shown in FIG. 5B, the separating web 42C is not also punched out of the corresponding lamination, but can be inserted once the laminate stack of the stator 6 is complete, possibly also together with the insertion of lines of the stator winding.

A further configuration is shown in FIG. 5D, in which the two limit slots 10D′ and 10D″ are now directly adjacent to one another, without a stator tooth in between. For the separation, a separating web 42D can be provided as insulating paper, for example, or can be dispensed with entirely. The limit slots 10D′ and 10D″ in this case have the same form as the remaining slots 10 and correspondingly have the same amount of space or the same size of space for receiving lines of the stator winding. When such lines of the stator winding are inserted, care would have to be taken to ensure that they come to lie as uniformly as possible in these two limit slots 10D′, 10D″ which are adjacent to one another without an intermediate tooth.

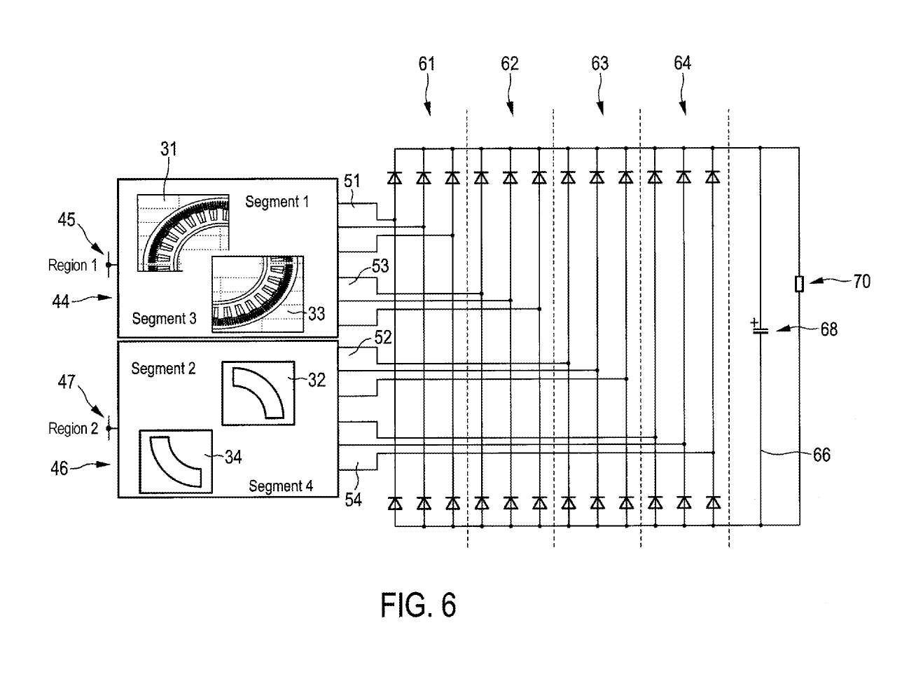

FIG. 6 illustrates the wiring of the stator windings of a synchronous generator according to the invention schematically in accordance with one embodiment. In this case, a synchronous generator with a split stator as shown in FIG. 4 is used as a basis. Therefore, four stator segments 31 to 34 are provided, wherein the first and third segments 31 and 33 are not offset or interleaved with respect to one another, but are interleaved with respect to the second and fourth segments 32 and 34. The second and fourth segments 32, 34 are likewise not interleaved or offset with respect to one another. The first and third segments 31, 33 are therefore illustrated schematically as a first region 44 or as a first segment group 44, and correspondingly the second and fourth segments 32, 34 are illustrated schematically as a second region 46 or a second segment group 46.

The two segment groups 44 and 46 each have two three-phase stator windings 51 and 53 and 52 and 54, respectively. In this case, in each case both stator windings 51 and 53 and 52 and 54 pass through in each case both segments 31 and 33 and 32 and 34, respectively, of the segment group 44 and 46 in question. The winding phases of in each case one stator winding 51 to 54 are connected electrically in series within a segment group 44 or 46, namely from a neutral point 45 or 47 (merely indicated) through a first stator segment 51 or 52, further through a second stator segment 53 or 54, and finally to one of the rectifiers 61 to 64. Therefore, two of the stator windings 51 to 54 pass through each segment.

In the embodiment shown, in this case each of the four stator windings 51 to 54 is connected individually to a first to fourth rectifier 61 to 64. All four rectifiers 61 to 64 in this case use the same DC link 66, into which they therefore all feed jointly. The DC link is also symbolized by a capacitor 68, and a load resistance 70 is symbolic of further elements to be connected, namely in particular one or more step-up converters to be connected and/or one or more inverters to be connected for producing a sinusoidal alternating current to be fed into an electrical supply grid.

The rectifiers 61 to 64 shown are each configured as passive, so-called B-6 rectifiers.

Owing to the fact that windings of both the first region 44 and the second region 46 are connected separately in each case to a rectifier or to a set of rectifiers, the currents generated differently in respect of any harmonics owing to the interleaving or the offset can also be passed correspondingly separately to the respective rectifier and therefore separately to the DC link 66 and are fed there by the rectifiers. The generated alternating currents are rectified by the rectification, but any harmonics or superimposed ripple remain substantially present and can then be present in the DC link, possibly in weakened form as voltage ripple or voltage fluctuations. In this case, the ripple which is to be assigned to the first region 44 is shifted with respect to the ripple which is to be assigned to the second region 46, and in the process superimposed in the DC link and can thus diminish one another. In the optimum at least theoretical case, the ripple of the first region 44 can be compensated for by the ripple of the second region 46.

By virtue of an additionally separate interconnection of the individual segments 31 to 34, in addition the redundancy of the generator, namely in particular of the stator, can be increased.

Therefore, a multipole synchronous ring generator of a wind turbine is proposed which can operate at reduced noise levels in particular in comparison with the previously known synchronous generators with an otherwise identical design.

In particular, a generator comprising six phases, namely a first and second system with in each case three phases, and a stator with 12 slots per pole pitch and a diode rectifier is also used as a basis. Such a multipole synchronous ring generator in accordance with the prior art can generate pulsating torques with harmonic contents of the 12th order, inter alia. Such pulsating torques can assume, for example, a frequency of approximately 120 Hz, which is naturally dependent on the speed, and can be disruptive.

A proposed solution therefore consists in dividing the stator winding or stator windings into segments, in particular into four segments. The slots of the segments are interleaved in such a way that a shift of half a slot pitch is produced between the segments, as shown in FIG. 4 with the enlargements 4A and 4B. Corresponding winding edge regions which can be in the form of a compressed region 36 or expanded region 38, which alternate over the circumference of the stator, result. The configuration of these winding edge regions can be as shown in FIGS. 5A to 5D. Further possible configurations are likewise not excluded.

In addition, it is proposed to interconnect in each case two non-adjacent segments, namely to form one region. Typically, this interconnection can take place by means of a series circuit. The interconnection in this case relates to three-phase winding phases in each case. Each interconnected region therefore consists of in each case two three-phase winding phases. Preferably, each region is connected to a 12-pulse diode rectification circuit and a DC voltage-side parallel circuit.

The proposed solution has been explained in particular using the example of the subdivision of a stator into four segments. However, other subdivisions can also be performed, in the simplest case a subdivision into two segments, in which case each individual segment also forms a region in the sense of the first or second region 44, 46. Likewise, a subdivision into considerably more than four segments, for example into an even number of segments, can be performed.

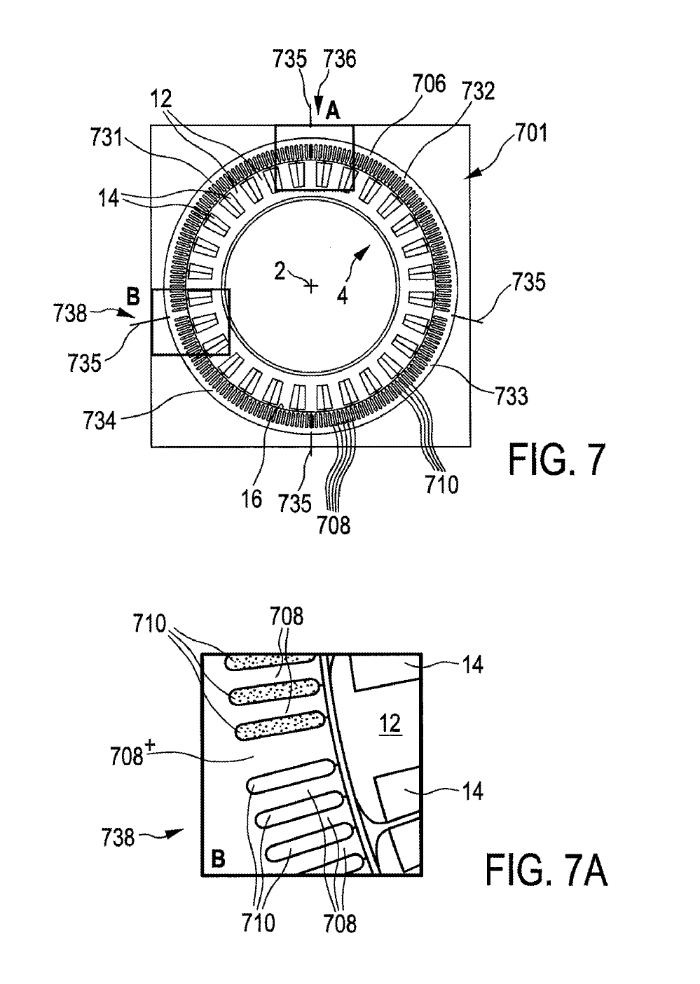

FIG. 7 shows, in a sectional view, a synchronous generator 701 comprising a stator 706 with four stator segments or segments 731 to 734. The stator segments 731 and 733 form a first segment group, and the stator segments 732 and 734 form a second segment group. Each of these segment groups 731, 733 and 732, 734 has 42 pole pairs and therefore a number or pole pairs which is not a multiple of four. Correspondingly, the stator segments of a segment group have different numbers of pole pairs, namely the first stator segment 731 has 24 pole pairs, and the second stator segment 733 has 18 pole pairs. Correspondingly, of the second segment group, the stator segment 732 has 24 pole pairs and, of the same segment group, the stator segment 734 has 18 pole pairs. Therefore, each of these four stator segments 731 to 734 also has, as the number of pole pairs, a multiple of six, or in other words the number of pole pairs of each of the stator segments 731 to 734 is divisible by the number six without remainder.

Moreover, the stator slots are identified by the reference symbol 710 and the stator teeth are identified by the reference symbol 708 in FIG. 7. The rotor 4 can correspond to the rotor 4 in FIG. 4, and to this extent reference is also made to the explanation in respect of FIG. 4 for the further description of said rotor.

The separation between the individual stator segments 731 to 734 is indicated by corresponding dashes 735. In comparison with the embodiment shown in FIG. 4, there is thus a shift of the expanded region 738, which likewise has a widened stator tooth 708⁺. This expanded region 738 with the widened tooth 708⁺ is arranged in the detail B in FIG. 7, which is illustrated in enlarged form in FIG. 7A. Apart from the shift of this expanded region 738 or widened tooth 708⁺, the rest of the descriptions in this regard apply to the embodiment shown in FIG. 4 and the enlarged illustration in FIG. 4B accordingly also for the embodiment in FIG. 7 or 7A.

The compressed region 736 is in principle unchanged and is also located at the marking A in FIG. 7. For this marking A, various variants are also possible, as are described in FIGS. 5A to 5D. To this extent, reference is made to these FIGS. 5A to 5D.

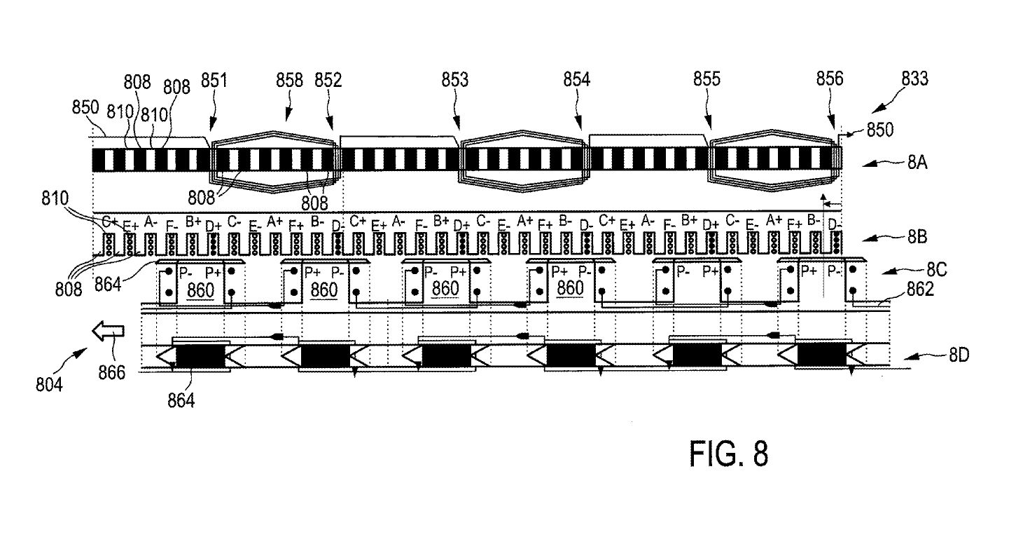

FIG. 8 illustrates the winding scheme for a synchronous generator in accordance with one embodiment for a stator segment, such as, for example, the stator segment 733 in FIG. 7 with 18 pole pairs. This stator segment, which has been given the reference symbol 833 in FIG. 8, is illustrated as an expanded element without curvature in FIG. 8 in order to simplify the illustration of the winding scheme thereby. FIG. 8 in this case shows a plan view of corresponding teeth 808 and slots 810 in view 8A, a side view of the stator segment 3 in view 8B, a side view of a likewise linearly illustrated part of the rotor 804 in view 8C, wherein the illustration is in this case also schematic and without curvature, and a plan view of the rotor teeth or pole shoes of the rotor 804 in the illustration 8D.

The view 8A in FIG. 8 illustrates the winding scheme in principle starting from the left with the winding phase 850, which is laid through a first slot 851, i.e., in principle in a forward direction, and is passed back through a second slot 852. This winding phase 850 is then passed to the first slot 851 and passed through there a further time and passed back again through second slot 852. This is repeated two further times so that the winding phase 850 is then laid around six teeth 808 in three complete loops 858. As a result, four turns are electromagnetically effective, however, because the winding phase entering at the beginning, which comes from the left as shown in FIG. 8, view 8A, is electrically effectively connected finally to that part of the winding phase 850 which leaves the second slot 852 towards the right finally, once at least the stator segment 833 shown is completely wound.

Once the winding phase 850 has been passed back through the second slot 852 for the fourth time, it is now inserted into a third slot 853 and passed back through a fourth slot 854, and this is repeated until again three loops or four electromagnetically effective turns are produced. However, this is repeated in a fifth and sixth slot 855 and 856, respectively, until the winding phase 850 has arrived on the right-hand side in FIG. 8, view 8A. From there, the winding phase 850 can be passed to a further stator segment, or connected to an output in order to provide a current to be generated there.

The view 8B shows schematically all of the teeth 808 and slots 810 of the stator segment 833. For illustrative purposes, the slots 810 are identified by A to F, wherein in each case one letter stands for a winding phase of a phase. The winding illustrated in view 8A in this case relates to the winding phase for the phase which is identified by the letter D. In this case, D+ in each case denotes the winding phase 850 being passed forwards and D− in each case identifies the winding phase 850 being passed back. The remaining letters A to C and E and F are provided with corresponding symbols, i.e., “+” for forwards and “−” for back.

The view 8B in FIG. 8 also shows that the winding phase is provided in each case in four layers in each stator slot 810. Moreover, the view 8B also indicates that in each case a corresponding winding is provided for the other phases A to C, E and F, as illustrated by the view for only one phase, namely phase D.

The view 8C shows, of the rotor 804, a detail with six pole shoes 860, which each have an alternating sense of direction, in order to generate in each case a magnetic field with reverse direction in relation to the respective adjacent pole shoe in the case of excitation by means of direct current in the field winding phases 862. Each pole shoe 860 has a pole shoe head 864, which is approximately in the form of an arrow, as can be seen from view 8D. The direction of movement of the rotor 804 is correctly in the direction of the movement arrow 866. Two pole shoes 860 and therefore two rotor poles, i.e., a rotor pole pair, extend in total over 12 stator teeth 808 or 12 stator slots 810 and therefore over six stator pole pairs.

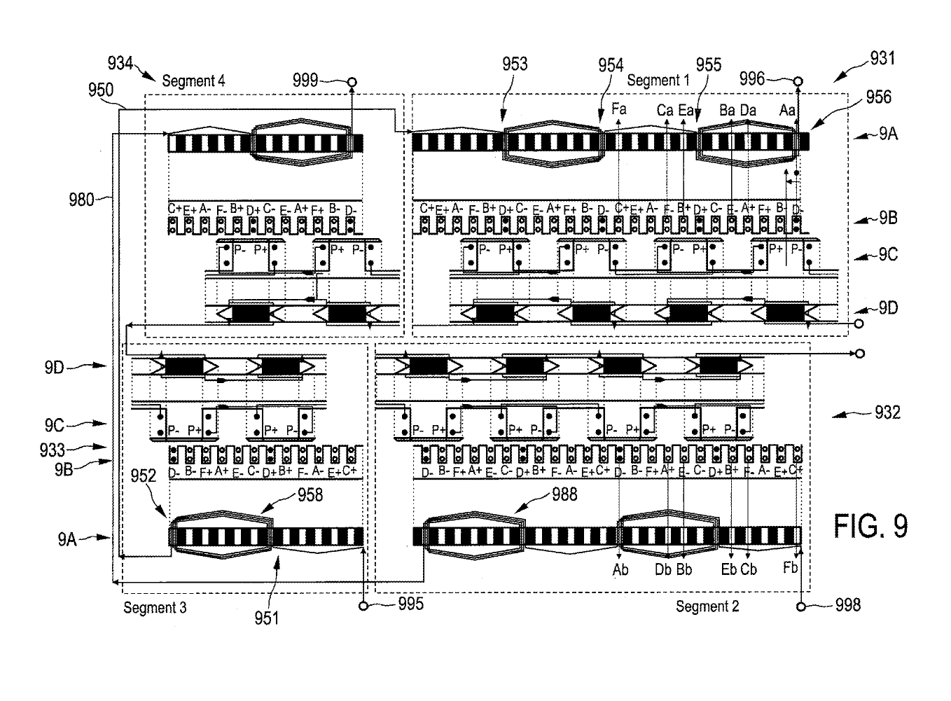

FIG. 9 shows or illustrates a winding scheme for a twelve-pole twelve-phase synchronous generator in a very similar illustration to that shown in FIG. 8. The basic synchronous generator has four segments 931 to 934. The first and third segments 931 and 933 form a first segment group, and the second and fourth segments 932 and 934 form a second segment group. Each of these two segment groups has two three-phase windings, i.e., in each case six windings. For illustrative purposes, however, in each case only one winding or only one winding phase 950 or 980 is illustrated. FIG. 9 likewise shows four views in the sense of views 8A to 8D, namely correspondingly as views 9A to 9D. However, only the illustration 9A shows a continuous winding phase 950 or 980.

For the first segment group consisting of the first and third segments 931 and 933, the winding phase 950 begins at a common neutral point 995. The winding phase 950 is part of a three-phase winding with two further winding phases (not illustrated in FIG. 9). These three winding phases therefore form a three-phase system and are connected to one another at the neutral point 995. From this neutral point 995, the winding phase 950 is first passed through a first slot 951 and passed back through a second slot 952 and laid through these two slots 951, 952 in three loops 958 and therefore four electromagnetically effective turns. Then, this winding phase 950 is passed onto the first segment 931 and is laid there through a third slot 953 and passed back through a fourth slot 954 until three loops have been formed. The winding phase then continues in a fifth slot 955 and is passed back through a sixth slot 956 a plurality of times so as to form three loops. Finally, the illustration for the winding phase 950 ends at a connection point 996. From this connection point, the winding phase 950 or another connected electrical line is passed to a rectifier, such as the B-6 rectifier 61 shown in FIG. 6, namely a branch with two diodes.

In the same way, the remaining slots are provided with the remaining five winding phases of these two three-phase systems, with the result that all of the slots of this first segment group of the first and second segments 931 and 933 are then filled.

Correspondingly, a winding of the second and fourth segments 932 and 934 of the second segment group with the winding phase 980 is performed. Said winding phase 980 is wound from the common neutral point 998 via a first to sixth slot 981 to 986 with corresponding loops 988 and ends at the connection point 999 for connection to a rectifier.

The synchronous generator shown in FIG. 9 has a first and a second segment group, each having 18 pole pairs. Therefore, four stator segments 931 to 934 are provided, which are each grouped into two segment groups 931 and 933 and 932 and 934. Each segment group therefore does not have a number of pole pairs which is a multiple of four and therefore the stator segments of a segment group have different numbers of pole pairs, namely the respectively larger stator segment 931 or 932 has twelve pole pairs and the respectively smaller stator segment 933 or 934 has six pole pairs. It will be mentioned that the interleaving provided has not been shown in FIG. 9 for reasons of simplified illustration of the winding scheme. FIG. 9 is intended to clarify the winding scheme.

1. A synchronous generator of a gearless wind turbine for generating electric current, the synchronous generator comprising:
a rotor; and
a stator having teeth and slots arranged between the teeth, the slots being configured for receiving a stator winding, wherein the stator is divided in a circumferential direction into a plurality of stator segments, each stator segment having a plurality of teeth and slots, and at least two stator segments being offset or interleaved with respect to one another in a circumferential direction.

2. The synchronous generator according to claim 1, wherein at least one tooth forms a stator pole, and two stator poles form a pole pair, and the number of pole pairs of each stator segment is a multiple of at least one of two and six.

3. The synchronous generator according to claim 1, wherein the plurality of stator segments are four stator segments, wherein the four stator segments are grouped into two segment groups, wherein the number of pole pairs of each of the two segment groups is a multiple of four or the stator segments of a segment group have different numbers of pole pairs.

4. The synchronous generator according to claim 1, wherein the slots and teeth of each stator segment are arranged equidistantly, and
at least two stator segments are offset or interleaved with respect to one another in the circumferential direction in such a way that adjacent teeth of the adjacent stator segments or adjacent slots of the adjacent stator segments have a different spacing from one another than adjacent teeth or slots of the same stator segment.

5. The synchronous generator according to claim 1, wherein:
a first and a second slot of a first stator segment or
a first and a second tooth of the first stator segment have an average spacing from one another of n×a, where:
a is an average spacing of two adjacent slots or teeth of the first stator segment, and
n is the number of slots between the first and second slots or teeth between the first and second teeth and is less than one, and wherein:
a first slot, with respect to a second slot that is on a second stator segment or
a first tooth, with respect to a second tooth that is on the second stator segment, has an average spacing of n×a+v or n×a−v, where v describes an offset or an interleaving between the first and second stator segments and is both greater than 0 and less than a.

6. The synchronous generator according to claim 5, wherein the offset or the interleaving has a value in the range of from 0.2×a to 0.3×a.

7. The synchronous generator according to claim 1, wherein:
each stator segment receives part of the stator winding as winding segment, and winding segments of non-adjacent stator segments of a segment group are interconnected with one another, wherein the winding segments are connected alternately to a first rectifier and a second rectifier, wherein the first and second rectifiers feed to a common DC link.

8. The synchronous generator according to claim 7, wherein winding segments of non-adjacent stator segments are coupled to one another electrically in series.

9. The synchronous generator according to claim 1, wherein:
the stator winding or the winding segments have, phase by phase, winding phases,
a winding phase is laid in a first stator segment through a first slot and passed back through a second slot,
the laying through the first and second slots is repeated such that at least one or three loops are laid through the first and second slots and around the teeth in between such that an electromagnetically effective turns number of four is provided, and
the laying of the winding phase is continued in a third and a fourth slot until the winding phase is passed to a first slot of a further stator segment or is connected there to a winding phase of the further stator segment, or is coupled to an output.

10. The synchronous generator according to claim 9, wherein five slots and six teeth are located between the first and second slots or in the at least one loop.

11. The synchronous generator according to claim 1, wherein a winding phase is wound continuously through at least one of the stator segments.

12. The synchronous generator according to claim 1, wherein at least one of the stator and the stator winding is point-symmetrical with respect to an axis of rotation of the synchronous generator.

13. The synchronous generator according to claim 1, wherein all of the slots in the stator are identical, wherein offset or interleaving of the stator segments is achieved by correspondingly matched teeth that are increased or reduced in size in the circumferential direction in the contact region of adjacent stator segments.

14. A set of laminations comprising:
a plurality of stator laminations for assembly to form a stator laminate stack, of a synchronous generator according to claim 1, wherein each stator lamination has a plurality of slot regions and a plurality of tooth regions for producing slots and teeth, and the set of laminations comprises:
at least one normal lamination with tooth regions and slot regions for producing identical slots and teeth, respectively,
at least one expanded lamination with an expanded region for producing a tooth or tooth region that is widened in the circumferential direction or a slot or slot region that is widened in the circumferential direction, and
at least one compressed lamination with a compressed region for producing a tooth or tooth region that is narrowed in the circumferential direction or a slot or slot region that is narrowed in the circumferential direction.

15. The set of laminations according to claim 14, wherein:
each expanded lamination has its expanded region eccentrically in the circumferential direction and the expanded region is mirror-symmetrical in the circumferential direction, and/or
the compressed region of each compressed lamination is eccentrically in the circumferential direction and the compressed region is mirror-symmetrical in the circumferential direction.

16. A method for producing a stator laminate stack, comprising the following steps:
producing a first lamination layer consisting of laminations, expanded laminations and compressed laminations of a set of laminations according to claim 10, wherein:
the expanded laminations are arranged in regions in which stator segments adjoin one another with a positive offset, and
the compressed laminations are arranged in regions in which stator segments adjoin one another with a negative offset,
producing a second lamination layer, wherein:
expanded laminations and compressed laminations are inverted with respect to the expanded laminations and compressed laminations, respectively, of the first layer in such a way that their upper side points downwards and their lower side points upwards, and the expanded lamination and compressed laminations are each laid one on top of the other with their expanded region or compressed region, as a result of which partial overlapping of the respective laminations results by virtue of the fact that the expanded regions or compressed regions are arranged eccentrically.

17. A wind turbine comprising a synchronous generator according to claim 1.

18. The synchronous ring generator according to claim 1, wherein the synchronous ring generator is a multipole synchronous ring generator.

19. The synchronous ring generator according to claim 1, wherein each stator segments receives part of the stator winding as winding segment, wherein each stator segments is connected in each case to a rectifier in the form of a B12 bridge.
